(19) United States
(12) Patent Application Publication
(10) Pub. No.: US 2018/0086370 A1
(43) Pub. Date: Mar. 29, 2018

(54) POWER STEERING GEAR ASSEMBLY HAVING AN END OF TRAVEL VALVE ASSEMBLY

(71) Applicant: Steering Solutions IP Holding Corporation, Saginaw, MI (US)

(72) Inventors: Albert C. Wong, Saginaw, MI (US); Thomas C. Rytlewski, Auburn, MI (US); Jason A. Dutsky, Bay City, MI (US)

(21) Appl. No.: 15/280,056

(22) Filed: Sep. 29, 2016

(51) Int. Cl. B62D 5/06; B62D 5/09; B62D 5/087; B62D 3/08; B62D 5/24; F15B 13/04

(52) U.S. Cl. CPC B62D 5/061; B62D 5/09; B62D 5/087; F16H 25/2204; B62D 5/24; F15B 13/0402; B62D 3/08

(57) ABSTRACT

A self-setting valve assembly includes a plug, a first plunger assembly, a second plunger assembly, and a biasing member. The plug has a first portion and a second portion. The first plunger assembly is movably disposed within the first portion. The second plunger assembly is movably disposed within the second portion. The biasing member is disposed between the first plunger assembly and the second plunger assembly. The biasing member is configured to bias each of the first plunger assembly and the second plunger assembly towards a closed position.

### BACKGROUND OF THE INVENTION

A power steering gear assembly is provided with a hydraulic pump that is configured to provide hydraulic power assist to a driver and a vehicle wheel. The power steering gear assembly is configured to stroke between axial stops or end of travel stops. As the power steering gear assembly approaches at least one of the end of travel stops, the hydraulic pump may be operating at pressure relief and the hydraulic power may be converted to heat and thus increase the working fluid temperature within the hydraulic pump. The increase in the working fluid temperature may cause high power consumption.

### SUMMARY OF THE INVENTION

According to an embodiment of the present disclosure, a power steering gear assembly is provided. The power steering gear assembly includes a gear housing, a hydraulic cylinder, and a valve assembly. The gear housing has a housing body that extends between a first housing end and a second housing end and an end wall disposed at the first housing end. The hydraulic cylinder is received within the gear housing. The hydraulic cylinder defines a bore that extends from a first cylinder end towards a second cylinder end. The valve assembly is at least partially received within and disposed proximate the first cylinder end. The valve assembly includes a plug, a first plunger assembly, a second plunger assembly, and a biasing member. The plug has a first portion that is received within the hydraulic cylinder and a second portion extending from the first portion. The first plunger assembly is movably disposed within the first portion. The second plunger assembly is movably disposed within the second portion in an opposed relationship with the first plunger assembly. The biasing member is disposed between the first plunger assembly and the second plunger assembly. The biasing member is configured to bias each of the first plunger assembly and the second plunger assembly towards a closed position.

According to another embodiment of the present disclosure, a valve assembly for a power steering gear assembly is provided. The valve assembly includes a plug, a first plunger assembly, a sleeve, and a second plunger assembly. The plug is connected to a hydraulic cylinder. The plug has a first portion that defines a first compartment, a first opening, and a first valve seat that extends between the first compartment and the first opening and a second portion that extends from the first portion. The second portion defines a second opening and a third opening. The first plunger assembly has a first plunger movably disposed within the first compartment and a first pin operatively connected to the first plunger and extending through the first opening. The sleeve is disposed within the third opening. The sleeve defines a second compartment, a sleeve opening, and a second valve seat extending between the second compartment and the sleeve opening. The second plunger assembly has a second plunger movably disposed within the second compartment and a second pin operatively connected to the second plunger and extending through the sleeve opening.

According to yet another embodiment of the present disclosure, a valve assembly for a power steering gear assembly is provided. The valve assembly includes a first plug, a second plug, a first plunger assembly, and a second plunger assembly. The first plug defines a first compartment, a first opening, a first valve seat extending between the first compartment and the first opening, a second opening, and a first shoulder extending between the second opening and the first compartment. The second plug is at least partially received within the second opening, the second plug defining a second compartment, a plug opening, and a second valve seat extending between the second compartment and the plug opening. The first plunger assembly is movably disposed within the first plug. The second plunger assembly movably disposed within the second plug.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional view of a portion of power steering gear assembly having a valve assembly;

FIG. 2 is a disassembled view of a valve assembly of the power steering gear assembly;

FIG. 3 is a cross-sectional view of the power steering gear assembly at a first end of travel;

FIG. 4 is a cross-sectional view of the power steering gear assembly at a second end of travel; and

FIG. 5 is a cross-sectional view of a portion of a power steering gear assembly having an alternative valve assembly configuration.

### DETAILED DESCRIPTION

Referring now to the Figures, where the invention will be described with reference to specific embodiments, without limiting same, it is to be understood that the disclosed embodiments are merely illustrative of the invention that is embodied in various and alternative forms. The figures are not necessarily to scale; some features are exaggerated or minimized to show details of particular components. Therefore, specific structural and functional details disclosed herein are not to be interpreted as limiting, but merely as a representative basis for teaching one skilled in the art to variously employ the present invention.

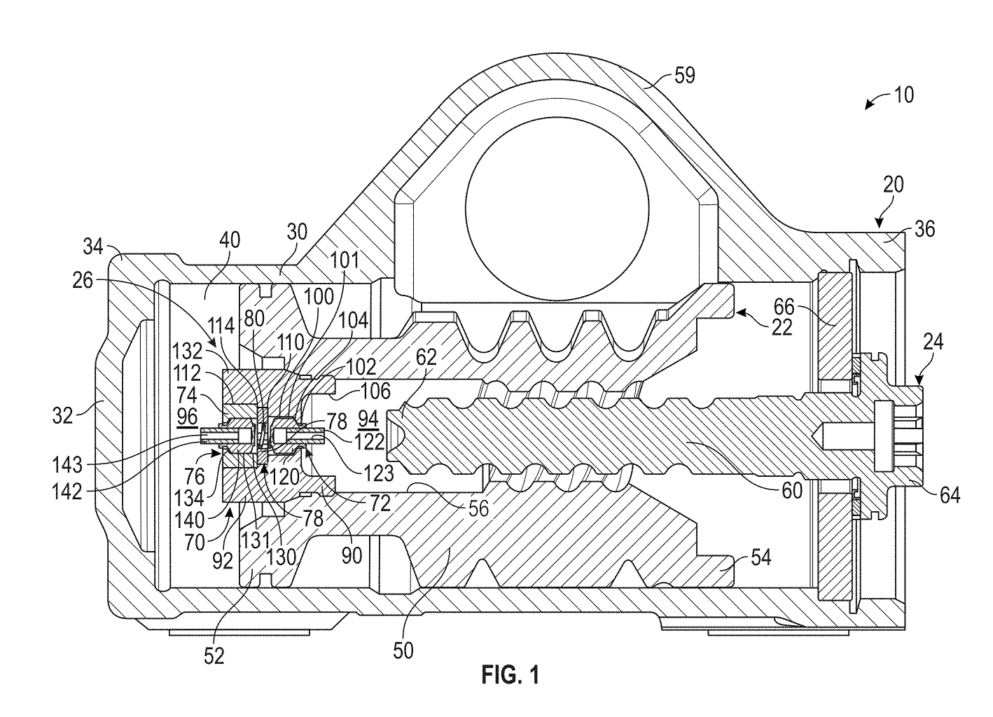

Referring to FIG. 1 a cross-sectional view of a power steering gear assembly 10 is shown. The power steering gear assembly 10 is provided with a vehicle such as an automobile, a truck, or the like. The power steering gear assembly 10 is configured to provide a power assist to an operator of the vehicle to turn or pivot steerable wheels of the vehicle. The power steering gear assembly 10 is configured to move along a steering stroke having stops or end of travel stops at opposite ends of a steering rack or the like.

The power steering gear assembly 10 includes a gear housing 20, a hydraulic cylinder 22, a ball screw 24, and an end of travel valve assembly 26. The gear housing 20 is disposed generally parallel to the steering stroke of the piston. The gear housing 20 includes a housing body 30 and an end wall 32. The housing body 30 extends between the first housing end 34 and a second housing end 36. The end wall 32 is disposed at the first housing end 34 and is disposed substantially perpendicular to the steering stroke of the piston. The housing body 30 and the end wall 32 define a cavity 40 that is configured to receive the hydraulic cylinder 22.

The hydraulic cylinder 22 is provided as part of a hydraulic gear. The hydraulic cylinder 22 includes a cylinder body 50 that extends between a first cylinder end 52 and a second cylinder end 54. The first cylinder end 52 is disposed proximate the first housing end 34. The cylinder body 50 defines a bore 56 that extends from the first cylinder end 52 towards the second cylinder end 54. The bore 56 extends completely through the cylinder body 50 such that the first cylinder end 52 and the second cylinder end 54 are each open ends.

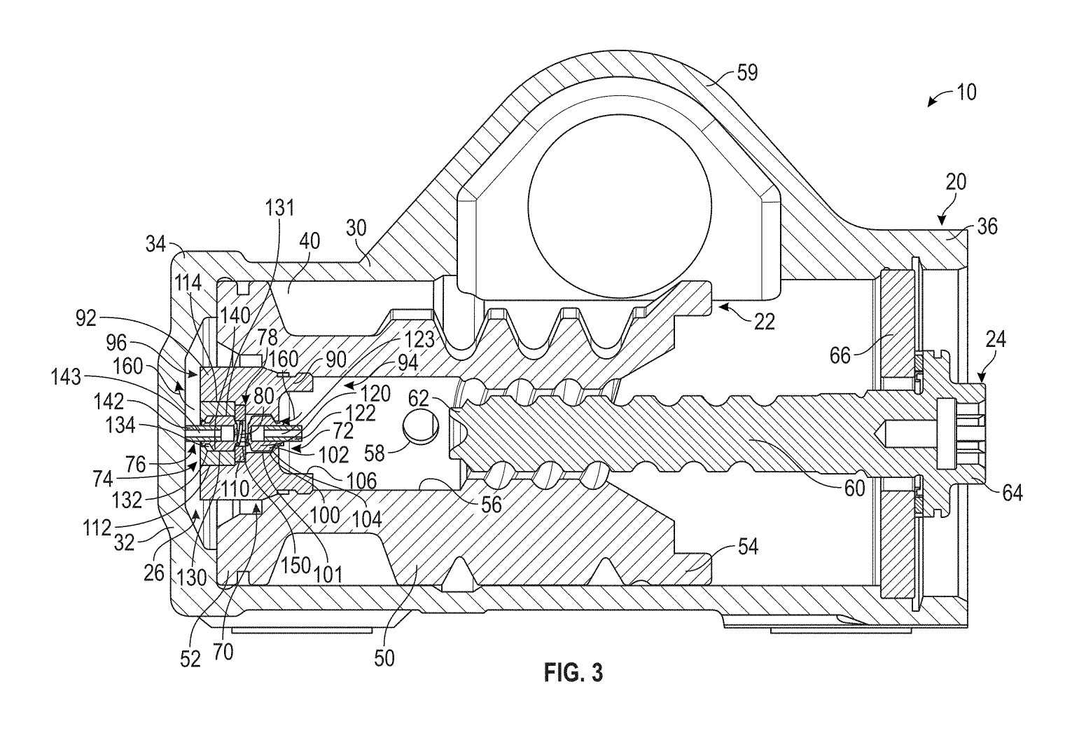

The cylinder body 50 further defines a body opening 58 (see FIG. 3) and a lobe 59. The body opening 58 is disposed between the first cylinder end 52 and the second cylinder end 54. The body opening 58 is disposed substantially transverse to the first cylinder end 52 and the second cylinder end 54. The lobe 59 extends away from the first cylinder end 52 and the second cylinder end 54 and is disposed between the first cylinder end 52 and the second cylinder end 54.

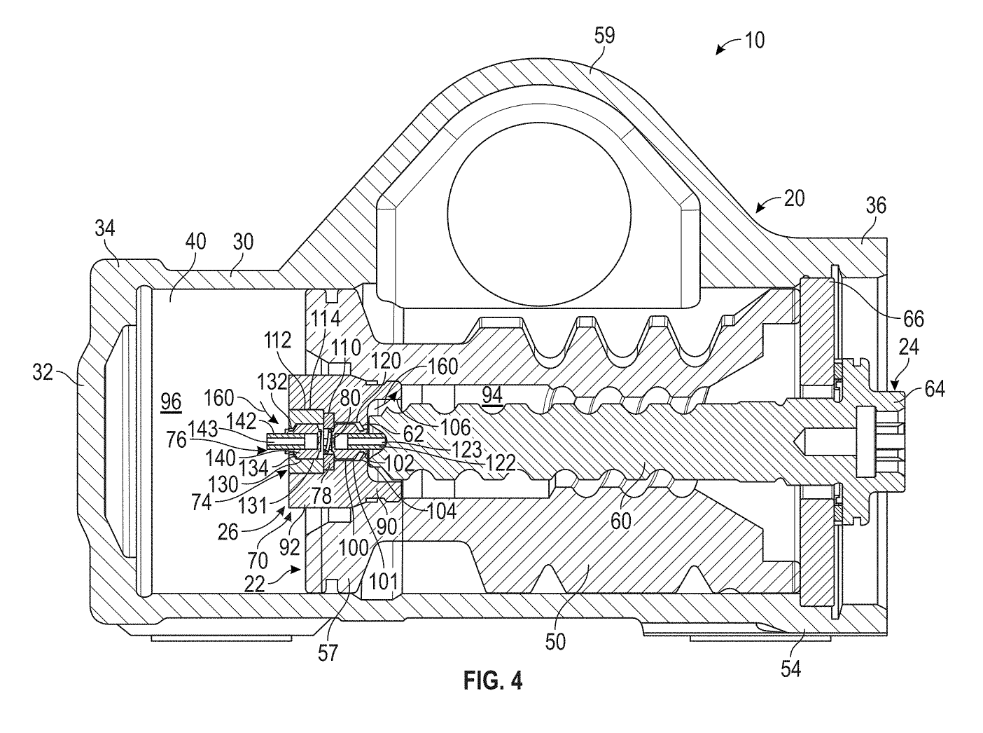

The ball screw 24 is received within the cavity 40 of the gear housing 20. The ball screw 24 extends at least partially into the bore 56 of the hydraulic cylinder 22. The ball screw 24 has a ball screw body 60 that extends from a first ball screw end 62 towards a second ball screw end 64. The first ball screw end 62 is disposed proximate the first cylinder end 52 of the hydraulic cylinder 22. The second ball screw end 64 is disposed proximate the second housing end 36 of the gear housing 20. The second ball screw end 64 is configured to be operatively connected to an input shaft that is configured to cause the hydraulic cylinder 22 to move relative to the ball screw 24. The rotation of at least one of the hydraulic cylinder 22 and the ball screw 24 causes the hydraulic cylinder 22 to move between the first housing end 34 (see FIG. 3) and the second housing end 36 (see FIG. 4).

The end wall 32 of the gear housing 20 defines a first end of travel stop of the power steering gear assembly 10. An end plate 66 that is disposed proximate the second ball screw end 64 and is operatively connected to the gear housing 20 proximate the second housing end 36 defines a second end of travel stop of the power steering gear assembly 10.

The end of travel valve assembly 26 is configured as an end of travel stop valve that releases fluid pressure within the power steering gear assembly 10. The end of travel valve assembly 26 prevents the hydraulic pump from operating at pressure relief. The end of travel valve assembly 26 allows fluid circulating through the gear housing 20, the hydraulic cylinder 22, the gear, hoses, cooler, reservoir, and hydraulic pump to be released to keep the operating temperature low. The end of travel valve assembly 26 is at least partially received within the hydraulic cylinder 22. The end of travel valve assembly 26 is configured as a self-setting valve assembly or a self-adjusting valve assembly that enables tight sealing and its simple design enables the cost of the end of travel valve assembly 26 to be low. The end of travel valve assembly 26 is disposed proximate the first cylinder end 52 of the hydraulic cylinder 22. The end of travel valve assembly 26 is configured as a pressure unloading valve that enables fluid communication between opposite sides of the end of travel valve assembly 26 in response to the hydraulic cylinder 22 of the power steering gear assembly 10 approaching or achieving the first end of travel stop (i.e. the end wall 32) and or the second end of travel stop (i.e. the end plate 66). The fluid communication between opposite sides of the end of travel valve assembly 26 release hydraulic pressure to reduce pressure within the gear housing 20 of the power steering gear assembly 10.

Referring to FIG. 4, the end of travel valve assembly 26 includes a plug 70, a first plunger assembly 72, a sleeve 74, a second plunger assembly 76, a washer 78, and a biasing member 80. The plug 70 is operatively connected to the first cylinder end 52 of the hydraulic cylinder 22.

The plug 70 includes a first portion 90 and a second portion 92 extending from the first portion 90. The plug 70 of the end of travel valve assembly 26 divides or defines a first chamber 94 and the second chamber 96. The first chamber 94 is defined by the first portion 90 of the plug 70, the first ball screw end 62, and at least a portion of the bore 56 of the hydraulic cylinder 22. The second chamber 96 is defined by a second portion 92 of the plug 70, the end wall 32 of the gear housing 20, and at least a portion of the cavity 40 of the gear housing 20.

The first portion 90 extends at least partially into the bore 56 of the hydraulic cylinder 22. The first portion 90 defines a first compartment 100, a first plug opening 102, a first valve seat 104, and a first receiving region 106. The first compartment 100 has a first diameter. The first plug opening 102 has a second diameter that is less than the first diameter. The first valve seat 104 extends between the first compartment 100 and the first plug opening 102. The first plug opening 102 is disposed between the first compartment 100 and the first receiving region 106. The first receiving region 106 is configured to at least partially receive the first ball screw end 62 while the hydraulic cylinder 22 approaches the end plate 66 or the second end of travel stop. The first receiving region 106 has a third diameter that is greater than the first diameter and that is greater than the second diameter.

The second portion 92 extends at least partially beyond the first cylinder end 52 of the hydraulic cylinder 22. The second portion 92 defines a second opening 110 and a third opening 112. The second opening 110 is disposed between the first compartment 100 and the third opening 112. The second opening 110 has a fourth diameter. The third opening 112 has a fifth diameter that is greater than the fourth diameter and is less than the third diameter.

The first plunger assembly 72 is movably disposed within the first portion 90 of the plug 70. The first plunger assembly 72 includes a first plunger 120 and a first pin 122.

The first plunger 120 is movably disposed within the first compartment 100. The first pin 122 is operatively connected to the first plunger 120. The first pin 122 extends from the first plunger 120 and extends through the first plug opening 102. The first pin 122 is press or slidingly fit into the first plunger 120. The first pin 122 position is automatically set after the first pin 122 engages the first ball screw end 62, after the first cycle of the power steering gear assembly 10. The position of the first pin 122 may remain set at this position during subsequent cycles of the power steering gear assembly 10.

The first plunger assembly 72 is movable between an open position and a closed position. The first plunger 120 is spaced apart from the first valve seat 104 while the first plunger assembly 72 is in the open position in response to the first pin 122 engaging the first ball screw end 62 or the end plate 66 and/or the second end of travel stop. The first plunger 120 is configured to engage the first valve seat 104 while the first plunger assembly 72 is in the closed position in response to or based on the first pin 122 being spaced apart from the first ball screw end 62 or the end plate 66 and/or the second end of travel stop.

The sleeve 74 is configured as a hollow member that is disposed within the third opening 112 of the second portion 92 of the plug 70. The sleeve 74 defines a second compartment 130, a sleeve opening 132, and a second valve seat 134. The second compartment 130 is disposed between the sleeve opening 132 and the second opening 110. The second valve seat 134 extends between the second compartment 130 and the sleeve opening 132.

The second plunger assembly 76 is movably disposed within the second portion 92 of the plug 70. The second plunger assembly 76 is disposed within and opposed relationship with the first plunger assembly 72. The second plunger assembly 76 includes a second plunger 140 and the second pin 142.

The second plunger 140 is movably disposed within the second compartment 130. The second pin 142 is operatively connected to the second plunger 140. The second pin 142 extends from the second plunger 140 and extends through the sleeve opening 132. The second pin 142 is press or slidingly fit into the second plunger 140. The second pin 142 position is automatically set after the second pin 142 engages the end wall 32, after the first cycle of the power steering gear assembly 10. The position of the second pin 142 may remain set at this position during subsequent cycles of the power steering gear assembly 10.

The second plunger assembly 76 is movable between an open position and a closed position. The second plunger 140 is spaced apart from the second valve seat 134 while the second plunger assembly 76 is in the open position in response to the second pin 142 engaging the end wall 32 and/or the first end of travel stop. The second plunger 140 is configured to engage the second valve seat 134 while the second plunger assembly 76 is in the closed position in response to or based on the second pin 142 being spaced apart from the end wall 32 and/or the first end of travel stop.

The washer 78 is disposed between the first plunger assembly 72 and the second plunger assembly 76 and is at least partially received within the second opening 110. The washer 78 abuts the first shoulder 114 and abuts the sleeve 74.

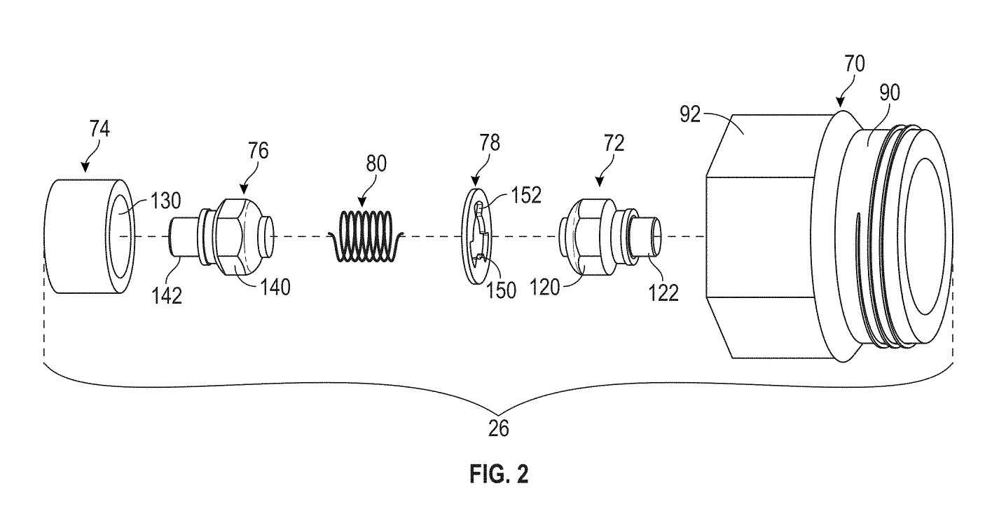

The washer 78 defines a central opening 150. In at least one embodiment, the washer 78 defines another opening 152 that extends from the central opening 150 towards a periphery of the washer 78. As illustrated in FIG. 2, at least three additional openings are provided such that the washer 78 includes a trilobular opening.

The biasing member 80 is disposed between the first plunger assembly 72 and the second plunger assembly 76. The biasing member 80 extends between the first plunger 120 and the second plunger 140 and extends through the central opening 150 of the washer 78. The biasing member 80 is configured to bias each of the first plunger assembly 72 and the second plunger assembly 76 towards their respective closed positions in which the first plunger 120 engages the first valve seat 104 and the second plunger 140 engages the second valve seat 134, respectively.

The end of travel valve assembly 26 defines a bypass flow path 160 through the end of travel valve assembly 26. The bypass flow path 160 facilitates or enables fluid communication between the first chamber 94 and the second chamber 96 through the end of travel valve assembly 26. The bypass flow path 160 is defined by the first plug opening 102 and the first plunger 120, the first compartment 100 and the first plunger 120, at least one of the central opening 150 and the another opening 152 of the washer 78, the second compartment 130 and the second plunger 140, and the sleeve opening 132 and the second plunger 140 while at least one of the first plunger 120 is spaced apart from the first valve seat 104 and the second plunger 140 is spaced apart from the second valve seat 134 in response to the second pin 142 engaging the end wall 32 and/or the first pin 122 engaging the first ball screw end 62.

As shown in FIG. 3, fluid communication between the first chamber 94 and the second chamber 96 is facilitated through the bypass flow path 160 of the end of travel valve assembly 26 in response to the second pin 142 of the second plunger assembly 76 engaging the end wall 32 to move at least one of the first plunger assembly 72 and the second plunger assembly 76 from the closed position towards the open position. As shown in FIG. 4, fluid communication between the first chamber 94 and the second chamber 96 is facilitated through the bypass flow path 160 of the end of travel valve assembly 26 in response to the first pin 122 of the first plunger assembly 72 engaging the first ball screw end 62 and/or the end plate 66 to move at least one of the first plunger assembly 72 and the second plunger assembly 76 from the closed position towards the open position.

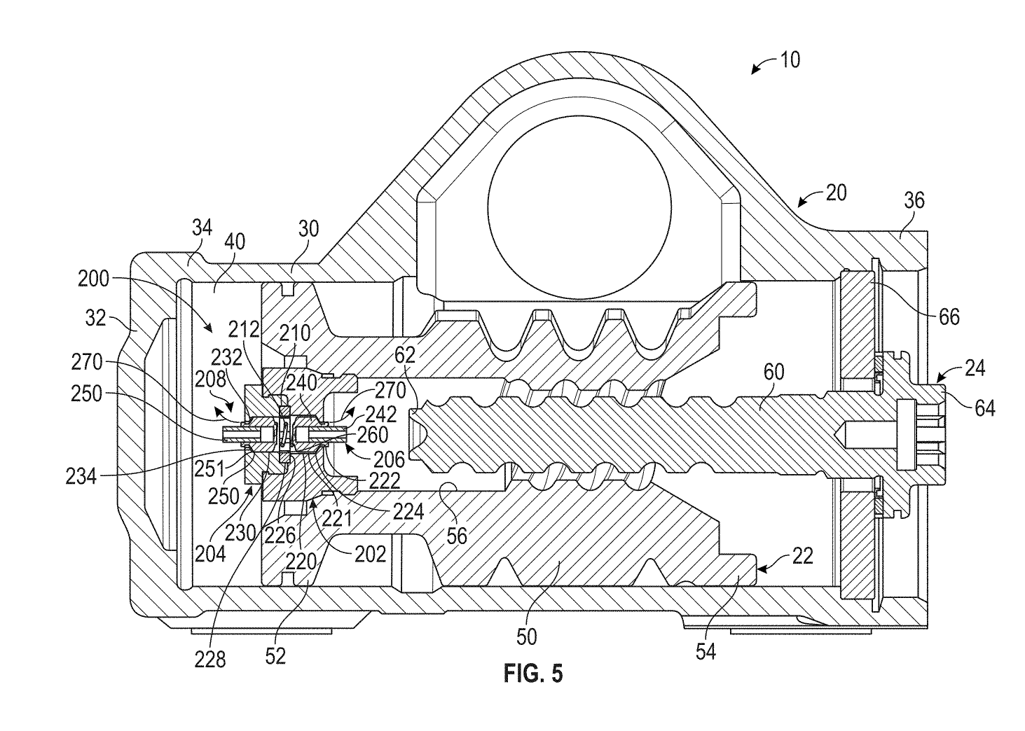

Referring to FIG. 5 a second embodiment of a valve assembly 200 is shown. The valve assembly 200 includes a first plug 202, a second plug 204, a first plunger assembly 206, a second plunger assembly 208, a washer 210, and a biasing member 212.

The first plug 202 is at least partially disposed within and is operatively connected to the first cylinder end 52 of the hydraulic cylinder 22. The first plug 202 defines a first compartment 220, a first opening 222, a first valve seat 224, a first shoulder 226, a second opening 228. The first opening 222 is disposed between the first shoulder 226 and the first valve seat 224. The first valve seat 224 extends between the first compartment 220 and the first opening 222. The first shoulder 226 is disposed between the second opening 228 in the first compartment 220.

The second plug 204 is operatively connected to the first plug 202. The second plug 204 is at least partially received within the second opening 228 of the first plug 202. The second plug 204 defines a second compartment 230, a plug opening 232, and a second valve seat 234. The second compartment 230 is disposed between the plug opening 232 and the second opening 228. The second valve seat 234 extends between the second compartment 230 and the plug opening 232.

The first plunger assembly 206 is movably disposed within the first plug 202. The first plunger assembly 206 includes a first plunger 240 and a first pin 242. The first plunger 240 is movably disposed within the first compartment 220. The first pin 242 extends from the first plunger 240 and extends through the first opening 222.

The first plunger assembly 206 is movable between an open position in which the first plunger 240 is spaced apart from the first valve seat 224 and a closed position in which the first plunger 240 engages the first valve seat 224. The first plunger assembly 206 is movable between the open position and the closed position in response to the first pin 242 engaging the first ball screw end 62 of the ball screw 24.

The second plunger assembly 208 is movably disposed within the second plug 204. The second plunger assembly 208 is disposed in an opposed relationship with respect to the first plunger assembly 206. The second plunger assembly 208 includes a second plunger 250 and a second pin 252.

The second plunger 250 is movably disposed within the second compartment 230. The second pin 252 extends from the second plunger 250 and extends through the plug opening 232. The second plunger assembly 208 is movable between an open position in which the second plunger 250 is spaced apart from the second valve seat 234 in a closed position in which the second plunger 250 engages the second valve seat 234. The second plunger assembly 208 is movable between the open position and the closed position in response to the second pin 252 engaging the end wall 32 of the gear housing 20.

The washer 210 is disposed between the first plug 202 and the second plug 204. The washer 210 is disposed within the second opening 228 and is disposed between the first plunger assembly 206 and the second plunger assembly 208. The washer 210 defines a central opening 262.

The biasing member 212 extends between the first plunger 240 of the first plunger assembly 206 and the second plunger 250 of the second plunger assembly 208. The biasing member 212 extends through the central opening 262 of the washer 260. The biasing member 212 is configured to bias the first plunger 240 of the first plunger assembly 206 towards the closed position and into engagement with the first valve seat 224. The biasing member 212 is configured to bias the second plunger 250 of the second plunger assembly 208 towards the closed position and into engagement with the second valve seat 234.

The valve assembly 200 defines a bypass flow path 270 through the valve assembly 200. The bypass flow path 270 facilitates or enables fluid communication between the first chamber 94 and the second chamber 96 through the first plug 202 and the second plug 204 of the valve assembly 200. The bypass flow path 270 is defined by the first opening 222 and the first plunger 240, the first compartment 220 and the first plunger 240, the central opening 262 of the washer 210, the second compartment 230 and the second plunger 250, and the plug opening 232 and the second plunger 250 while at least one of the first plunger 240 is spaced apart from the first valve seat 224 and the second plunger 250 is spaced apart from the second valve seat 234 in response to engagement between the second pin 252 and a steering gear assembly component such as the end wall 32 and/or engagement between the first pin 242 and a steering gear assembly component such as the first ball screw end 62. At least one of the first plunger assembly 206 and the second plunger assembly 208 inhibits fluid communication between the first chamber 94 and the second chamber 96 through the bypass flow path 270 while at least one of the first plunger 240 of the first plunger assembly 206 engages the first valve seat 224 and the second plunger 250 of the second plunger assembly 208 engages the second valve seat 234.

Throughout this specification, the term “attach,” “attachment,” “connected”, “coupled,” “coupling,” “mount,” or “mounting” shall be interpreted to mean that a structural component or element is in some manner connected to or contacts another element, either directly or indirectly through at least one intervening structural element, or is integrally formed with the other structural element.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description.

1. A power steering gear assembly, comprising:
a gear housing having a housing body that extends between a first housing end and a second housing end and an end wall disposed at the first housing end;
a hydraulic cylinder received within the gear housing, the hydraulic cylinder defining a bore that extends from a first cylinder end towards a second cylinder end; and
a self-setting valve assembly at least partially received within and disposed proximate the first cylinder end, the self-setting valve assembly comprising:
a single-piece plug including a first portion that is received within the hydraulic cylinder and a second portion extending from the first portion,
a first plunger assembly slidably engaged with a first bore of a first compartment defined by the first portion,
a second plunger assembly slidably engaged with a second bore of a second compartment that is defined by a sleeve that is disposed within a sleeve opening defined by the second portion, the second plunger assembly being in an opposed relationship with the first plunger assembly, and
a biasing member disposed between the first plunger assembly and the second plunger assembly, the biasing member configured to bias each of the first plunger assembly and the second plunger assembly towards a closed position.

2. The power steering gear assembly of claim 1, further comprising a ball screw that is received within the gear housing and extends at least partially into the hydraulic cylinder towards the self-setting valve assembly.

3. The power steering gear assembly of claim 2, wherein the first portion of the plug, an end of the ball screw, and at least a portion of the hydraulic cylinder defines a first chamber.

4. The power steering gear assembly of claim 3, wherein the second portion of the plug, the end wall, and a portion of the housing body define a second chamber.

5. The power steering gear assembly of claim 4, wherein in response to the first plunger assembly engaging the end of the ball screw, at least one of the first plunger assembly and the second plunger assembly is moved towards an open position that facilitates fluid communication between the first chamber and the second chamber through the self-setting valve assembly.

6. The power steering gear assembly of claim 4, wherein in response to the second plunger assembly engaging the end wall of the gear housing, at least one of the first plunger assembly and the second plunger assembly is moved towards an open position that facilitates fluid communication between the first chamber and the second chamber through the self-setting valve assembly.

7. A valve assembly for a power steering gear assembly, the valve assembly comprising:
a single-piece plug connected to a hydraulic cylinder, the plug having a first portion defining a first compartment, a first opening, and a first valve seat extending between the first compartment and the first opening and a second portion extending from the first portion, the second portion defining a second opening and a third opening;
a first plunger assembly having a first plunger movably disposed within the first compartment and a first pin operatively connected to the first plunger and extending through the first opening, the first pin defining a first pin opening extending at least partially through the first pin;
a sleeve disposed within the third opening, the sleeve defining a second compartment, a sleeve opening, and a second valve seat extending between the second compartment and the sleeve opening; and
a second plunger assembly having a second plunger slidably engaged with a second bore of the sleeve and a second pin operatively connected to the second plunger and extending through the sleeve opening, the second pin defining a second pin opening extending at least partially through the second pin.

8. The valve assembly of claim 7, wherein the plug defines a first shoulder that extends between the first compartment and the second opening.

9. The valve assembly of claim 8, further comprising a washer that abuts the first shoulder and is disposed between the sleeve and the first plunger assembly.

10. The valve assembly of claim 9, further comprising a biasing member disposed between the first plunger and the second plunger.

11. The valve assembly of claim 10, wherein the biasing member extends through the washer.

12. The valve assembly of claim 10, wherein a bypass flow path is defined by the first opening and the first plunger, the first plunger and the first compartment, the washer, the second plunger and the second compartment, and the second plunger and the sleeve opening while at least one of the first plunger is spaced apart from the first valve seat and the second plunger is spaced apart from the second valve seat.

13. The valve assembly of claim 12, wherein the biasing member biases the first plunger towards engagement with the first valve seat and the second plunger towards engagement with the second valve seat to inhibit fluid communication through the bypass flow path.

14. A valve assembly for a power steering gear assembly, the valve assembly comprising:
a first plug defining a first compartment, a first opening, a first valve seat extending between the first compartment and the first opening, a second opening, and a first shoulder extending between the second opening and the first compartment;
a second plug that is at least partially received within the second opening, the second plug defining a second compartment, a plug opening, and a second valve seat extending between the second compartment and the plug opening;
a washer defining a central opening and another opening that extends from the central opening towards a periphery of the washer, the washer being disposed between the first plug and the second plug;
a first plunger assembly slidably engaged with a first bore of the first compartment of the first plug; and
a second plunger assembly slidably engaged with a second bore of the second compartment of the second plug.

15. The valve assembly of claim 14, wherein the first plunger assembly comprising:
a first plunger movably disposed within the first compartment; and
a first pin extending from the first plunger and through the first opening, the first pin defining a first pin opening extending at least partially through the first pin.

16. The valve assembly of claim 15, wherein the second plunger assembly comprising:
a second plunger movably disposed within the second compartment; and
a second pin extending from the second plunger and through the plug opening, the second pin defining a second pin opening extending at least partially through the second pin.

17. (canceled)

18. The valve assembly of claim 16, further comprising a biasing member extending between the first plunger and the second plunger and through the central opening of the washer.

19. The valve assembly of claim 18, wherein the biasing member is configured to bias the first plunger towards engagement with the first valve seat and to bias the second plunger towards engagement with the second valve seat to inhibit fluid communication through the first plug and the second plug.

20. The valve assembly of claim 18, wherein in response to engagement of at least one of the first pin and the second pin with a steering gear assembly component, at least one of the first plunger is spaced apart from the first valve seat and the second plunger is spaced apart from the second valve seat to facilitate fluid communication through the first plug and the second plug.
